(19) United States
(12) Patent Application Publication
(10) Pub. No.: US 2014/0324987 A1
(43) Pub. Date: Oct. 30, 2014

(54) METHOD FOR COMMUNICATING WITH A PUBLIC ID AND PUBLIC ID ASSISTANT DEVICE

(71) Applicant: Xiao Long Zhang, Shenzhen (CN)

(72) Inventor: Xiao Long Zhang, Shenzhen (CN)

(21) Appl. No.: 13/993,300

(22) PCT Filed: Apr. 28, 2013
(86) PCT No.: PCT/CN2013/074986

§ 371 Date: Jun. 11, 2013

(51) Int. Cl. H04L 12/58

(52) U.S. Cl. CPC H04L 51/04
USPC 709/206

(57) ABSTRACT

This disclosure provides methods for communicating with a public ID and public ID assistant devices for assisting in communicating with a public ID. The method includes: receiving a message sent to the public ID; determining whether there is a private ID associated with the public ID; sending, if there is a private ID associated with the public ID, the message to the private ID taking an assistant ID as a sender of the message; wherein the message sent to the private ID comprises information indicating that the message is sent from which buddy of the public ID to the public ID or the message is a system message sent from a WeChat server to the public ID; and the assistant ID is a system ID or a private ID in a buddy list of the private ID. With the technical scheme of the present disclosure, the user may receive messages from and send messages to his/her buddy in time and conveniently.

### FIELD OF THE INVENTION

The present disclosure relates to a field of Instant Messaging (IM), and more particularly, to methods for communicating with a pubic ID and public ID assistant devices for assisting in communicating with a public ID.

### BACKGROUND

Instant Messaging (IM) is a form of communication over the Internet that offers quick transmission of messages from sender to receiver. It may address point-to-point communications as well as multicast communications from one sender to many receivers. More advanced instant messaging allows enhanced modes of communication, such as live voice or video calling, video chat and inclusion of hyperlink to media.

WeChat is a new and powerful IM tool. WeChat supports sending voice, video, photo and text messages. With the WeChat, the user may also do group chats, or find new buddies nearby to talk to. WeChat works on devices, on which intelligent Operating Systems (OSs) are installed, such as iOS, Android, Windows Phone, Symbian and Blackberry. The devices, on which the intelligent OSs are installed, are called intelligent devices. The intelligent device, on which the IM software is installed, is called an IM client device. After the WeChat is installed on the IM client device, the user may log on the WeChat, open a session interface, and chat with a buddy.

The public IDs are owned by Companies, brands and celebrities registering on a public platform and providing services to the private IDs who concern them, such as selling stuff or sending news update, discount voucher, company announcements to the private IDs. At present, if the user wishes to logs on the public platform, the user needs to open a browser, input the website of the public platform, and log on the public platform using his/her public ID. The user may receive and send information with the public platform using the web. Accordingly, if the user receives a message from his/her buddies but the user logs out of the public platform, the user cannot see this message at this moment. Alternatively, if the user wants to sends a message to his/her buddies but it is inconvenient for the user to log on the public platform using the web page at the moment, the user cannot send the message to his/her buddies in time. In view of the above, with the conventional method, the user using the public ID cannot send messages to or receive messages from his/her buddies in time and conveniently.

### SUMMARY

In view of the above, the present disclosure provides methods for communicating with a public ID and public ID assistant devices for assisting in communicating with a public ID, by which the user may receive messages from and send messages to the buddies of the public ID or the WeChat server in time and conveniently.

A first example of the present disclosure provides a method for communicating with a public Identity (ID), including:

receiving a message sent to the public ID;

determining whether there is a private ID associated with the public ID; and

sending, if there is a private ID associated with the public ID, the message to the private ID taking an assistant ID as a sender of the message;

wherein the message sent to the private ID comprises information indicating that the message is sent from which buddy of the public ID to the public ID or the message is a system message sent from a WeChat server to the public ID; and

the assistant ID is a system ID or a private ID in a buddy list of the private ID.

A second example of the present disclosure provides a method for communicating with a public ID, including:

receiving a message sent from a private ID to an assistant ID;

determing whether there is a public ID associated with the private ID;

sending out, if there is a public ID associated with the private ID, the message taking the public ID as the sender of the message; wherein

the assistant ID is a system ID or a private ID in a buddy list of the private ID.

A third method provides a public Identity (ID) assistant device for assisting in communicating with a public ID. The device comprises: a memory, a processor and an interface; wherein

the memory is to store a corresponding relationship between the public ID and each private ID; and

the processor is to

receive a message sent to the public ID via the interface;

determine whether there is a private ID associated with the public ID by searching for the memory;

send, if there is a private ID associated with the public ID, the message to the private ID via the interface taking an assistant ID as a sender of the message;

wherein the message sent to the private ID comprises information indicating that the message is sent from which buddy of the public ID to the public ID or the message is a system message sent from a WeChat server to the public ID; and

the assistant ID is a system ID or a private ID in a buddy list of the private ID.

A fourth example of the present disclosure provides a public Identity (ID) assistant device for assisting in communicating with a public ID. The device comprises: a memory, a processor and an interface; wherein

the memory is to store a corresponding relationship between the public ID and each private ID; and

the processor is to

receive a message sent from a private ID to an assistant ID via the interface;

determine whether there is a public ID associated with the private ID by searching for the memory; and

send out, if there is a public ID associated with the private ID, the message taking the public ID as the sender of the message; wherein

the assistant ID is a system ID or a private ID in a buddy list of the private ID.

In view of the above, if it is determined that a private ID is associated with the public ID, the message sent to the public ID is sent to the private ID. In this technical scheme, the information indicating that the message is sent from which buddy of the public ID to the public ID or the message is a system message sent from a WeChat server to the public ID is sent to the private ID, by which the user may know who send this message to his/her public ID. In this way, the user needs not to log on the public platform using the web to receive the message. Instead, the user may receive the message sent to the public ID using the private ID on a WeChat client device conveniently and in time.

### BRIEF DESCRIPTION OF THE DRAWINGS

Features of the present disclosure are illustrated by way of non-limiting examples in the following figure(s), in which:

FIG. 1 is a flow chart illustrating a first method for communicating with a public ID in accordance with an example of the present disclosure;

FIG. 2 is a schematic diagram illustrating a system in which the public ID assistant device is a separate physical entity;

FIG. 3 is a schematic diagram illustrating a system in which the public ID assistant device is integrated into the WeChat server;

FIG. 4 is a flow chart illustrating a second method for communicating with a public ID in accordance with an example of the present disclosure;

FIG. 5 is a schematic diagram illustrating a first public ID assistant device for assisting in communicating with a public ID in accordance with an example of the present disclosure;

FIG. 6 is a schematic diagram illustrating a second public ID assistant device for assisting in communicating with a public ID in accordance with an example of the present disclosure;

FIG. 7 is a schematic diagram illustrating a third public ID assistant device for assisting in communicating with a public ID in accordance with an example of the present disclosure; and

FIG. 8 is a schematic diagram illustrating a fourth public ID assistant device for assisting in communicating with a public ID in accordance with an example of the present disclosure.

### DETAILED DESCRIPTION

For simplicity and illustrative purposes, the present disclosure is described by referring to non-limiting examples. In the following description, numerous specific details are set forth in order to provide a thorough understanding of the present disclosure. It will be readily apparent however, that the present disclosure may be practiced without limitation to these specific details. In some instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

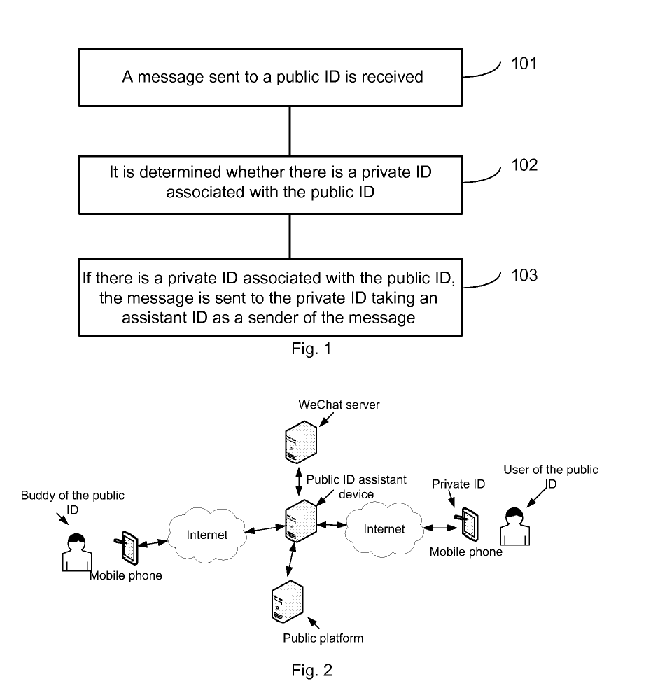

Referring to FIG. 1, FIG. 1 is a flow chart illustrating a first method for communicating with a public ID in accordance with an example of the present disclosure. The method includes the following blocks.

In block 101, a message sent to a public ID is received.

In block 102, it is determined whether there is a private ID associated with the public ID.

In block 103, if there is a private ID associated with the public ID, the message is sent to the private ID taking an assistant ID as a sender of the message.

The message sent to the private ID comprises information indicating that the message is sent from which buddy of the public ID to the public ID or the message is a system message sent from a WeChat server to the public ID. The assistant ID is a system ID or a private ID in a buddy list of the private ID.

In view of the above, if a private ID associated with the public ID is found, the message sent to the public ID is sent to the private ID. In this method, the information indicating that the message is sent from which buddy of the public ID to the public ID or the message is a system message sent from a WeChat server to the public ID is sent to the private ID, by which the user may know who send this message to his/her public ID. In this way, the user needs not to log on the public platform using the web to receive the message. Instead, the user may receive the message sent to the public ID with a WeChat client device conveniently and in time.

In above block 101, the user, such as a big star, typically keeps two IDs, i.e. the public ID and the private ID. The big star may log on the public platform on the web using the public ID, and interact with his/her buddies, such as fans. In this method, if a fan of the big star sends a message to the public ID of the big star, the message may be received by the public ID assistant device.

As a big star, he/she may have a lot of fans. In order to better interact with his/her fans, the big star may make some configurations to associate his/her public ID with his/her one or multiple private IDs. The corresponding relationship between the public ID and each private ID may be preset. In block 102, after receiving the message sent to the public ID of the big star, it is determined whether there is a private ID associated with the public ID by searching for the corresponding relationship between the public ID and the each private ID. In practice, before determing whether there is a private ID associated with the public ID, the method further includes determining whether the message needs to be sent to the public ID or a private ID according to a preset rule. Only when the message needs to be sent to the private ID, the method for determining whether there is private ID associated with the public ID is performed. Not all the messages sent to the public IDs should be sent to the private IDs. Only when the user using the public ID subscribes the assistant service, the message sent to the public ID is sent to the private ID of the user. If the user does not subscribe the assistant service, the message is still sent to the public ID, and the user still needs to log on the public platform using the web and view the message.

In the above two blocks, the message sent to the public ID of the big star may be received by the public ID assistant device and it is determined that there is a private ID associated with public ID of the big star. In block 103, since the fan of the big star cannot interact with the private ID of the big star directly, the public ID assistant device replaces the sender, i.e. the private ID of the fan with a new sender, i.e. the assistant ID of the public ID assistant device if a private ID associated with the public ID of the big star is found.

Then, the message is sent to the private ID of the big star. In this way, the big star may view the message sent from his/her fan to his/her public ID with the WeChat installed on his/her mobile phone. The big star may have a lot of fans, and the public ID of the big star receives a lot of messages from these fans each day. In addition, the public ID of the big star may receive some system messages from the WeChat server. In order to distinguish the messages sent from his/her fans and the messages sent from the WeChat server, and further to distinguish from which fan the message is sent from, the information indicating that the message is sent from which buddy of the public ID of the big star to the public ID or the message is a system message sent from the WeChat server to the public ID of the big star is sent to the private ID. In this way, after pulling the message with his/her private ID, the big star may clear see what his/her fan says to him/her, or a notification pushed by the WeChat server to his/her public ID.

After receiving the message sent to the public ID of the big star, the public ID assistant device may also send the message to the public platform. Through this “synchronization mode”, the big star may also logs on the public platform to view the message in addition to view the message using the WeChat installed in his/her mobile phone.

In practice, the assistant ID of the public ID assistant device may be a specific system ID, such as a system ID for pushing news to the user, or an ordinary private ID. If the assistant ID is an ordinary private ID, the big star needs to add the assistant ID to his/her buddy list. Only in this way, the public ID assistant device may send the message to the private ID using the assistant ID.

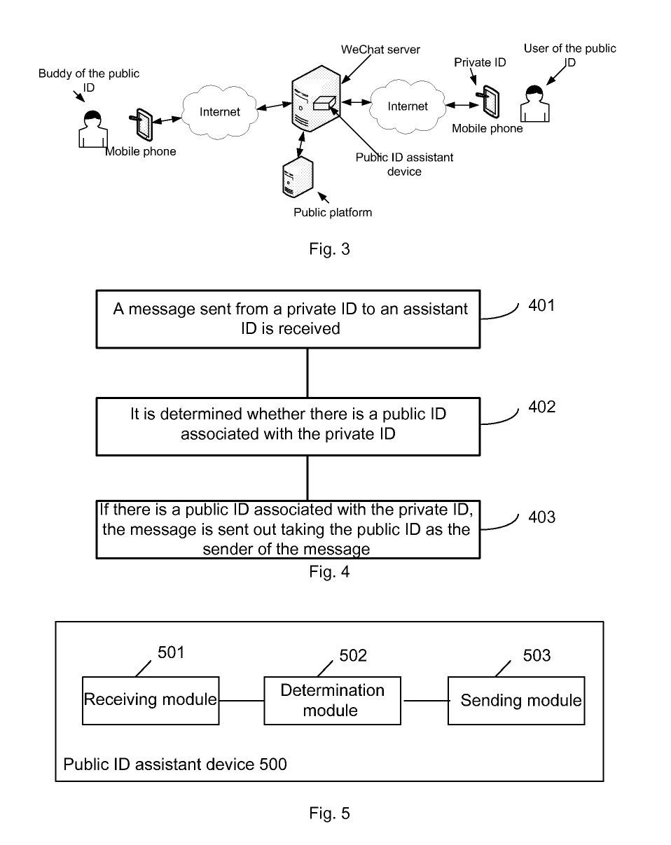

The above method may be implemented with the public ID assistant device keeping the assistant ID. The public ID assistant device may be a separate physical entity or a physical entity integrated into the WeChat server. FIG. 2 is a schematic diagram illustrating a system in which the public ID assistant device is a separate physical entity. FIG. 3 is a schematic diagram illustrating a system in which the public assistant device is integrated into the WeChat server.

The above method describes a method for sending the message sent to the public ID to the private ID. The method for sending the message sent from a private ID is described hereinafter.

Referring to FIG. 4, FIG. 4 is a flow chart illustrating a second method for communicating with a public ID in accordance with an example of the present disclosure. The method includes the following blocks.

In block 401, a message sent from a private ID to an assistant ID is received.

In block 402, it is determined whether there is a public ID associated with the private ID.

In block 403, if there is a public ID associated with the private ID, the message is sent out taking the public ID as the sender of the message.

The assistant ID is a system ID or a private ID in a buddy list of the private ID

In view of the above method, the message sent from the private ID to the assistant ID is received, after determining that there is a public ID associated with the private ID, and the message is sent out taking the public ID as the sender of the message. In this way, the user may log a WeChat client device with the private ID, and send the message out using the his/her public ID, instead of logging on the public platform via the web and sending the message out on the public platform. Typically, compared with sending the message via the public platform, the method for sending out the message using the WeChat client device is simple and fast. Therefore, with the technical scheme of this method, the user may send the message using the public ID conveniently and fast.

Again, taking the above mentioned big star and his/her fans for example, in block 401, if the big star wants to send out a message using his/her public ID, he/she logs on a WeChat client device, sends the message to the assistant ID using the private ID.

In block 402, after receiving the message, the public ID assistant device determines whether there is a public ID associated with the private ID by searching for a corresponding relationship between the public ID and each private ID.

In block 403, if the public ID associated with the private ID is found, it is determined that the message should be sent out taking the public ID as the sender. When the message is received from the private ID, the sender of the message is the private ID. After receiving the message, the private ID is replaced with the public ID, i.e. the public ID is configured as the sender of the message.

The public ID assistant device sends the message to a buddy of the public ID or sent to the WeChat server. In practice, the message sent out may be a reply made by the big star to a fan. In this way, the message is sent to the private ID of the fan. Sometimes, the message is a system response message made by the big star to the WeChat server. Accordingly, the message is sent to the WeChat server.

In practice, the assistant ID of the public ID assistant device may be a specific system ID, such as a system ID for pushing news to the user, or an ordinary private ID. If the assistant ID is an ordinary private ID, the big star needs to add the assistant ID to his/her buddy list. Only in this way, the private ID may send the message to the assistant ID of the public ID assistant device.

The above blocks 401 to 403 may be performed by a public ID assistant device, and the public ID assisitant device keeps the assistant ID. The public ID assistant device may be a separate physical entity or a physical entity integrated into the WeChat server. The specific structure of the public ID assistant device is respectively shown in FIGS. 2 and 3.

The methods for communicating with the public ID are described above with reference to FIGS. 1 and 4. Referring to the examples in the accompanying drawings, the public ID assistant devices for assisting in communicating with a public ID are given hereinafter.

Referring to FIG. 5, FIG. 5 is a schematic diagram illustrating a first public ID assistant device for assisting in communicating with a public ID in accordance with an example of the present disclosure. The public ID assistant device 500 includes: a receiving module 501, a determination module 502, and a sending module 503.

The receiving module 501 is to receive a message sent to the public ID.

The determination module 502 is to determine whether there is a private ID associated with the public ID.

The sending module 503 is to send, if there is a private ID associated with the public ID, the message to the private ID taking an assistant ID as a sender of the message.

The message sent to the private ID includes information indicating that the message is sent from which buddy of the public ID to the public ID or the message is a system message sent from a WeChat server to the public ID.

The determination module 502 may further determine whether the message sent to the public ID should be sent to the public ID or a private ID according to a preset rule, and send the message to the public ID after determing that the message should be sent to a private ID.

The sending module 503 may further send the message sent to the public ID to the public platform for synchronization.

In practice, the assistant ID of the public ID assistant device may be a specific system ID, such as a system ID for pushing news to the user, or an ordinary private ID. If the assistant ID is an ordinary private ID, the user needs to add the assistant ID to his/her buddy list. Only when the assistant ID is a buddy of the private ID, the public ID assistant device may send the message to the private ID using the assistant ID.

The public ID assistant device may be a separate physical entity or a physical entity integrated into a WeChat server.

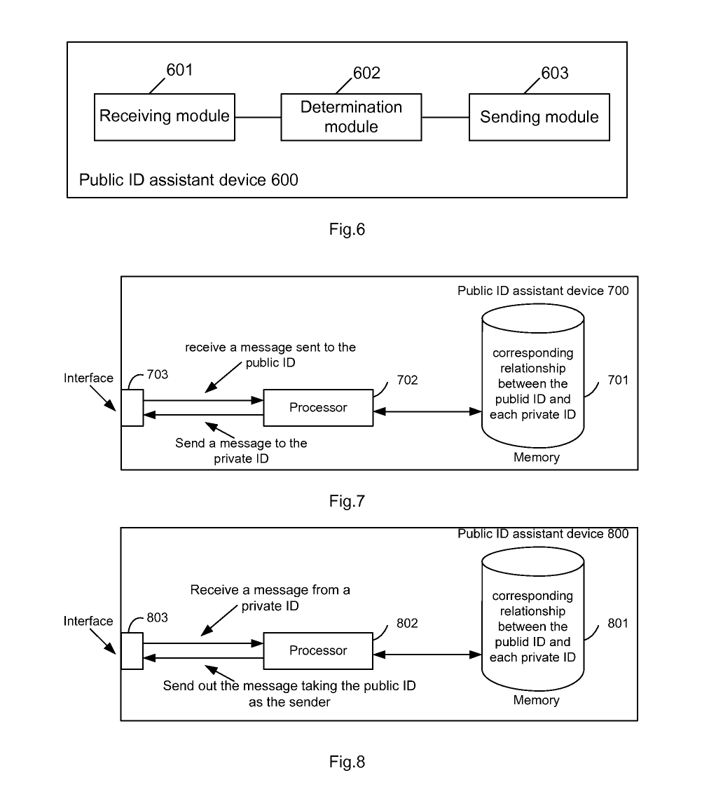

Referring to FIG. 6, FIG. 6 is a schematic diagram illustrating a second public ID assistant device for assisting in communicating with a public ID in accordance with an example of the present disclosure. The public ID assistant device 600 includes: a receiving module 601, a determination module 602, and a sending module 603.

The receiving module 601 is to receive a message from a private ID to an assistant ID.

The determination module 602 is to determine whether there is a public ID associated with the private ID.

The sending module 604 is to send out, if there is a public ID associated with the private ID,the message taking the public ID as the sender of the message.

The assistant ID is a system ID or a private ID in a buddy list of the private ID.

In practice, the assistant ID of the public ID assistant device may be a specific system ID, such as a system ID for pushing news to the user, or an ordinary private ID. If the assistant ID is an ordinary private ID, the user needs to add the assistant ID to his/her buddy list. Only when the assistant ID is a buddy of the private ID, the public ID assistant device may receive the message from the private ID using the assistant ID.

The public ID assistant device may be a separate physical entity or a physical entity integrated into a WeChat server.

Referring to FIG. 7, FIG. 7 is a schematic diagram illustrating a third public ID assistant device for assisting in communicating with a public ID in accordance with an example of the present disclosure. The public ID assistant device 700 includes: a memory 701, a processor 702 and an interface 703.

The memory 701 is to store a corresponding relationship between the public ID and each private ID.

The processor 702 is to

receive a message sent to the public ID via the interface 703;

determine whether there is a private ID associated with the public ID by searching for the memory;

send, if there is a private ID associated with the public ID, the message to the private ID via the interface 703 taking an assistant ID as a sender of the message.

The message sent to the private ID includes information indicating that the message is sent from which buddy of the public ID or the message is a system message sent from a WeChat server. The assistant ID is a system ID or a private ID in a buddy list of the private ID.

In practice, the processor 702 is further to send the message sent to the public ID to a public platform via the interface 703.

In practice, the assistant ID of the public ID assistant device may be a specific system ID, such as a system ID for pushing news to the user, or an ordinary private ID. If the assistant ID is an ordinary private ID, the user needs to add the assistant ID to his/her buddy list. Only when the assistant ID is a buddy of the private ID, the public ID assistant device may send the message to the private ID using the assistant ID.

The public ID assistant device 700 is a separate physical entity or a physical entity integrated into a WeChat server.

The processor 702 is further to

determine whether the message sent to the public ID is sent to the public ID or a private ID according to a preset rule; and

determine whether there is a private ID associated with the public ID if the message is determined to be sent to a private ID.

Referring to FIG. 8, FIG. 8 is a schematic diagram illustrating a fourth public ID assistant device for assisting in communicating with a public ID in accordance with an example of the present disclosure. The public ID assistant device 800 includes: a memory 801, a processor 802 and an interface 803.

The memory 801 is to store a corresponding relationship between the public ID and each private ID.

The processor 802 is to

receive a message sent from a private ID to an assistant ID via the interface 803;

determine whether there is a public ID associated with the private ID by searching for the memory 801; and

send out, if there is a public ID associated with the private ID, the message taking the public ID as the sender of the message via the interface 803; wherein the assistant ID is a system ID or a private ID in a buddy list of the private ID.

In practice, the assistant ID of the public ID assistant device may be a specific system ID, such as a system ID for pushing news to the user, or an ordinary private ID. If the assistant ID is an ordinary private ID, the user needs to add the assistant ID to his/her buddy list. Only when the assistant ID is a buddy of the private ID, the public ID assistant device may receive the message from the private ID using the assistant ID.

The public ID assistant device is a separate physical entity or a physical entity integrated into a WeChat server.

The processor 802 is further to send the message to a buddy of the public ID, or send the message to a WeChat server via the interface 803.

In the present disclosure, the public ID assistant device is a device for assisting in communicating with the public ID. The assistant function is implemented with the assistant ID. The assistant ID is a super ID, such as a system ID, or a private ID in the buddy list of the private ID. In practice, if a message is sent to the public ID, the message sent to the public ID is sent to the private ID by taking the assistant ID as the sender of the message. If a message needs to be sent to a buddy of the public ID or the WeChat server, the message is sent to assistant ID from the private ID, and sent to the buddy or the WeChat server taking the public ID as the sender. With the assistant ID, the user may receive a message sent to his/her public ID using the private ID by logging on the WeChat client device, such as a mobile phone, on which the WeChat is installed, and send a message to the buddy of the public ID or the WeChat server using the private ID by logging on the WeChat client device. That is, the public ID assistant device assists the user in implementing all or partial of the functions of public ID using the WeChat client device, such as the mobile phone.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), a digital versatile disk (DVD), an erasable programmable read-only memory (EPROM or Flash memory), an optical fiber, a portable compact disc read-only memory (CD-ROM), an optical storage device, a magnetic storage device, or any tangible medium that can contain, or store a program for use by or in connection with an instruction execution system, apparatus, or device.

The figures are only illustrations of an example, wherein the modules or procedure shown in the figures are not necessarily essential for implementing the present disclosure. The modules in the aforesaid examples can be combined into one module or further divided into a plurality of sub-modules.

The above are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for communicating with a public Identity (ID), comprising:
receiving a message sent to the public ID;
determining whether there is a private ID associated with the public ID; and
sending, if there is a private ID associated with the public ID, the message to the private ID taking an assistant ID as a sender of the message;
wherein the message sent to the private ID comprises information indicating that the message is sent from which buddy of the public ID to the public ID or the message is a system message sent from a WeChat server to the public ID; and
the assistant ID is a system ID or a private ID in a buddy list of the private ID.

2. The method according to claim 1, further comprising:
sending the message sent to the public ID to a public platform.

3. The method according to claim 1, further comprising:
determing whether the message sent to the public ID is sent to the public ID or a private ID according to a preset rule; wherein
determining whether there is a private ID associated with the public ID comprises:
determining whether there is a private ID associated with the public ID if the message is determined to be sent to the private ID.

4. A method for communicating with a public ID, comprising:
receiving a message sent from a private ID to an assistant ID;
determing whether there is a public ID associated with the private ID;
sending out, if there is a public ID associated with the private ID, the message taking the public ID as the sender of the message; wherein
the assistant ID is a system ID or a private ID in a buddy list of the private ID.

5. The method according to claim 4, wherein the message is sent to a buddy of the public ID or sent to a WeChat server.

6. A public Identity (ID) assistant device for assisting in communicating with a public ID, wherein the device comprises: a memory, a processor and an interface; wherein
the memory is to store a corresponding relationship between the public ID and each private ID; and
the processor is to
receive a message sent to the public ID via the interface;
determine whether there is a private ID associated with the public ID by searching for the memory;
send, if there is a private ID associated with the public ID, the message to the private ID via the interface taking an assistant ID as a sender of the message;
wherein the message sent to the private ID comprises information indicating that the message is sent from which buddy of the public ID to the public ID or the message is a system message sent from a WeChat server to the public ID; and
the assistant ID is a system ID or a private ID in a buddy list of the private ID.

7. The public ID assistant device according to claim 6, wherein the processor is further to send the message sent to the public ID to a public platform via the interface.

8. The public ID assistant device according to claim 6, wherein the processor is further to
determine whether the message sent to the public ID is sent to the public ID or a private ID according to a preset rule; and
determine whether there is a private ID associated with the public ID if the message is determined to be sent to a private ID.

9. A public Identity (ID) assistant device for assisting in communicating with a public ID, wherein the device comprises: a memory, a processor and an interface; wherein
the memory is to store a corresponding relationship between the public ID and each private ID; and
the processor is to
receive a message sent from a private ID to an assistant ID via the interface;
determine whether there is a public ID associated with the private ID by searching for the memory; and
send out, if there is a public ID associated with the private ID, the message taking the public ID as the sender of the message; wherein
the assistant ID is a system ID or a private ID in a buddy list of the private ID.

10. The public ID assistant device according to claim 9, wherein the processor is further to send the message to a buddy of the public ID or send the message to a WeChat server via the interface.
